(19) United States
(12) Patent Application Publication
(10) Pub. No.: US 2005/0064893 A1
(43) Pub. Date: Mar. 24, 2005

(54) Upgrading cellular telephones

(76) Inventor: Kelan C. Silvester, Portland, OR (US)

Correspondence Address: Timothy N. Trop;TROP, PRUNER & HU, P.C., STE 100, 8554 KATY FWY, HOUSTON, TX, 77024-1805, US

(21) Appl. No.: 10/964,259

(22) Filed: Oct. 12, 2004

Related U.S. Application Data
(62) Division of application No. 09/974,588, filed on Oct. 9, 2001.

(51) Int. Cl. H04M 1/00

(52) U.S. Cl. 455/550.1

(57) ABSTRACT

A cellular telephone may be equipped with a compartment that slidingly receives upgrade modules, such as PC or memory cards. The modules may provide added functionality, such as wireless Ethernet connection, additional memory, pre-programmed memory, additional processing, better displays, and the like. By simply unplugging an existing card from its compartment and inserting in its place a new card, upgraded features may be pluggingly provided to cellular telephones.

### BACKGROUND

This invention relates generally to cellular telephones.

Existing cellular telephones come in a variety of price ranges. Cell phones at the bottom price ranges come with very rudimentary features. For example, basic cell phones may include a baseband processor or a digital signal processor, but they may not include an application processor to provide advanced features, such as address books, phone directories, and advanced call features, to mention a few examples. The hope of the cellular telephone providers is that ultimately the cell phone users will progress to ever more advanced cellular telephones.

However, when a cellular telephone user decides to upgrade to a more advanced cellular telephone, his or her existing cellular telephone becomes largely useless. The market for resale of basic cellular telephones is relatively limited.

Therefore, it would be desirable to enable cellular telephones that may be both mass produced and user configurable.

### BRIEF DESCRIPTION OF THE DRAWINGS

FIG. 1 is a front elevational view of one embodiment of the present invention;

FIG. 2 is an exploded front elevational view of the embodiment shown in FIG. 1;

FIG. 3 is a schematic depiction of the cellular telephone shown in FIG. 1 in accordance with one embodiment of the present invention;

FIG. 4 is a perspective view of another embodiment of the present invention;

FIG. 5 is a rear elevational view of still another embodiment of the present invention; and

FIG. 6 is a perspective view of still another embodiment of the present invention.

### DETAILED DESCRIPTION

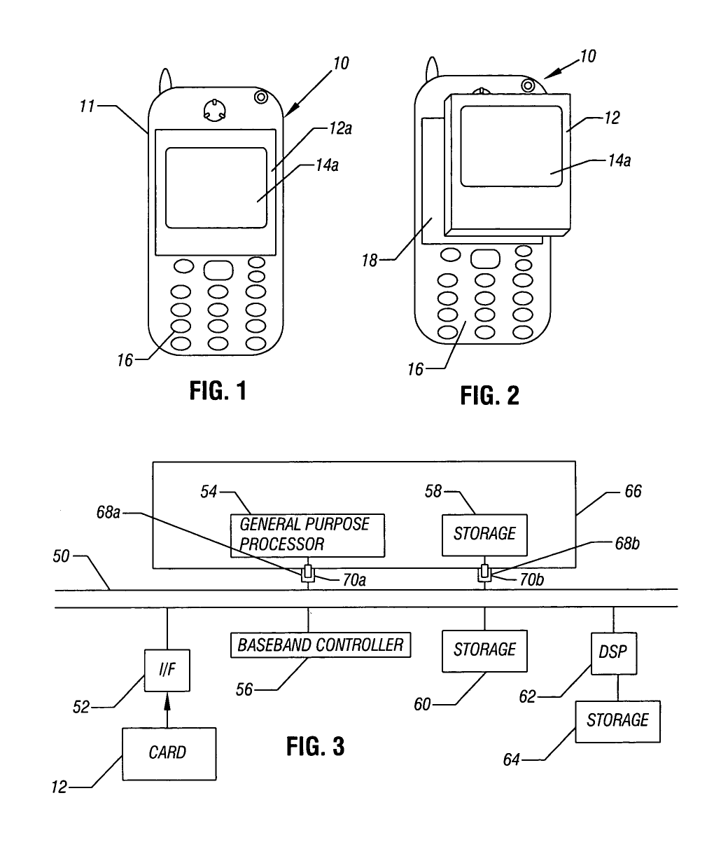

Referring to FIG. 1, a cellular telephone 10 may include a housing 11 that slidingly receives a replaceable module 12a. The housing 11 may also include a keyboard 16 in some embodiments.

Thus, referring to FIG. 2, the replaceable module 12a is slidingly received into a compartment 18 through the front surface of the housing 11.

In some embodiments, this slideably received module 12a may include a display 14a and a variety of other upgrade components including upgraded memory, an upgraded processor, an upgraded display, as well as upgraded software in some embodiments. Thus, by simply replacing one module 12a with another module, the cellular telephone 10 may be upgraded to attain new and/or different functionalities.

Referring to FIG. 3, a basic cellular telephone may include a bus 50 that communicates with a baseband controller 56 and a storage 60 for the baseband controller 56. In some embodiments, a digital signal processor (DSP) 62 may be coupled to the bus 50. The DSP 62 may include its own storage 64. An interface 52 may be provided to interact with one or more modules 12. The module 12 may be a PC card or a memory card, or any of a variety of cards that provide upgraded capabilities to the cellular telephone 10.

A card 66 may also be coupled into the bus 50 through contacts 68a and 68b. The contacts 68a and 68b may be slideable contacts so that the card 66 simply plugs into the connectors 70a and 70b that in turn couple the card 66 electrically to the bus 50. In one embodiment, the contacts 68 may be provided on the rear side of the module 12a.

The card 66, in one embodiment, may include a general purpose or applications processor 54 and a storage 58 for the processor 54. Thus, in some embodiments, a variety of additional functions, beyond simply completing cellular telephone calls, may be provided using the card 66. For example, the general purpose processor 54 and storage 58 may include software to implement personal information manager (PIM) functions, such as address books, games, scheduling, calculator functions and the like. Thus, the user may simply replace an existing module 12 with an upgrade module 12 and/or provide a new upgrade card 66 that provides additional processing capabilities.

As a result, in some embodiments, users may custom configure their cell phones to include that hardware and software that the user actually wants. In addition, a user may purchase a relatively basic cellular telephone and then may upgrade with those capabilities the user desires.

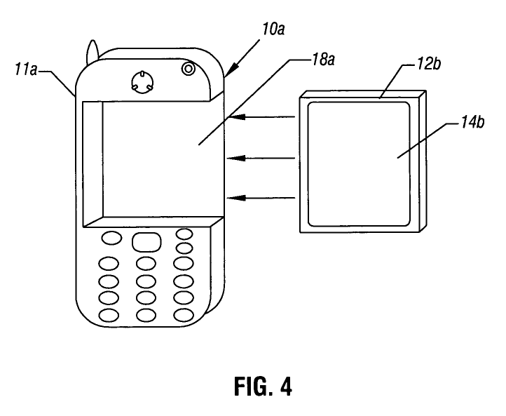

Referring to FIG. 4, in accordance with another embodiment of the present invention, a slideably received module 12b may slide sideways into the housing 11a into a compartment 18a that opens on one side of the housing 11a. The module 12b may include an enhanced display 14b that provides more functions than the module 12a in one embodiment. Thus, one module 12 may simply be unplugged and another module 12 slidingly plugged into the compartment 18a.

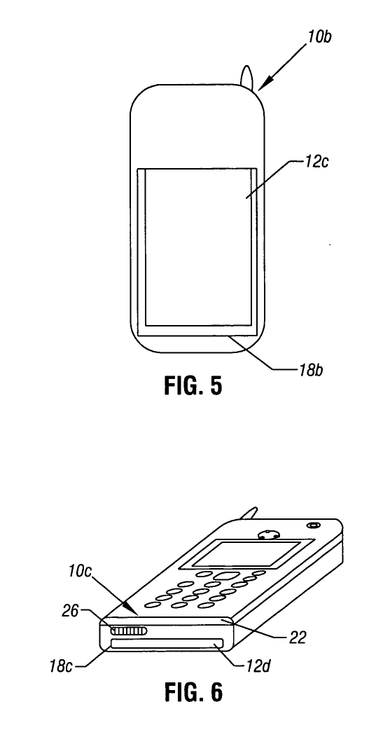

Turning next to FIG. 5, a cellular telephone 10b may receive a slidably pluggable module 12c through the battery compartment 18b with the battery removed. In other words, the module 12c may be plugged in with the battery removed, the battery may then be replaced over the module 12c and then the cover (not shown) may be secured on the housing 11.

Referring finally to FIG. 6, in accordance with still another embodiment, a compartment 18c may slidingly receive a module 12d through the bottom end 22 of the cellular telephone 10c. A catch 26 may be provided to releasably lock the module 12d within the compartment 18c. The upgrade modules 12 may be flash memory cards in one embodiment, or they may be PC cards in another embodiment. PC or memory cards may be plugged in as cards with new functions are developed.

For example, a cellular telephone with a PC card can use an Ethernet adapter to plug into a local area network, for example, through an 802.11 wireless connection for fast access to data (IEEE Standard 802.11 available from the Institute of Electrical and Electronics Engineers, New York, N.Y.). In addition, memory cards, such as flash memory cards that are either programmable or pre-programmed with desired data, may be plugged into the cellular telephone 10.

In some embodiments, the cellular telephone 10 may receive memories that were programmed to store data at other processor-based devices, such a laptop or desktop computer. The memory can then simply be removed from the other processor-based system and plugged into the cellular telephone 10 to provide enhanced features for the cellular telephone 10. This operation may enhance the use of the cellular telephone 10 because it is not necessary to use a limited keyboard 16 to enter the data. Instead, the data can be loaded through a more fully featured processor-based system. The pre-programmed memory can then be plugged into the phone 10.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. A cellular telephone comprising:
a housing;
a processor in said housing;
a battery in said housing;
a compartment in said housing, said compartment being accessible beneath the battery; and
a sliding coupling in said compartment to slidingly receive a removable module and to couple the module to the processor.

2. The telephone of claim 1 including a removable module.

3. The telephone of claim 2 wherein said module includes a display.

4. The telephone of claim 2 wherein said module includes a processor.

5. The telephone of claim 2 wherein said module includes additional memory.

6. The telephone of claim 2 wherein said module includes an Ethernet adapter.

7. The telephone of claim 2 wherein said processor is a baseband processor and said module includes an applications processor.

8. The telephone of claim 1 wherein said housing includes a front face having a keyboard, said compartment opening in said front face to receive said module.

9. (Canceled).

10. The telephone of claim 1 wherein said housing includes a front face including a keyboard, a rear face, and opposed ends, one of said ends including a slot to access the compartment in said housing.

11. A method comprising:
providing a cellular telephone including a compartment beneath a battery to receive replaceable modules; and
providing a plurality of replaceable modules having different capabilities that may be slid into the compartment of said cellular telephone to upgrade said cellular telephone.

12. The method of claim 11 including providing a module that includes a display.

13. The method of claim 11 including providing a module that includes a processor.

14. The method of claim 11 including providing a module that includes additional memory.

15. The method of claim 11 including providing a module with an Ethernet adapter.

16. The method of claim 11 including providing a module that includes an applications processor.

17. The method of claim 11 including providing an opening in the front face of said telephone to receive said module.

18. (Canceled).

19. The method of claim 11 including providing a slot in the cellular telephone's housing to slidingly receive a module.

20. The method of claim 11 including providing a plug-in connection in the compartment for a module.

21-25. (Canceled).
